(19) United States
(12) Patent Application Publication
(10) Pub. No.: US 2006/0158120 A1
(43) Pub. Date: Jul. 20, 2006

(54) Plasma display apparatus

(76) Inventors: Ki-Jung Kim, Suwon-si (KR); Kyoung-Ho Kang, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/335,308

(22) Filed: Jan. 19, 2006

(30) Foreign Application Priority Data
Jan. 20, 2005 (KR) 10-2005-0005376

(51) Int. Cl. H01J 61/30

(52) U.S. Cl. 313/634

(57) ABSTRACT

A plasma display device that can prevent the penetration of moisture or impurities into terminal units through a connection portion is disclosed. The device uses a protection member covering outer sides of the connection portion between the terminal units of electrodes and conductive wires of a connection member. The device includes a plasma display panel displaying an image, the plasma display panel comprising a front panel, a rear panel, and a terminal region formed at least on an edge between the front panel and the rear panel to locate terminal units of electrodes that are extended to be exposed, and a chassis base located on the rear of the plasma display panel. The device further includes at least one circuit substrate located on the rear of the chassis base to drive the plasma display panel, a plurality of connection members, one end of which is located on the plasma display panel and other end of which is located on the circuit substrate, and each connection member comprising a wire unit having conductive wires which correspond to the terminal units and are respectively connected to terminal units using an adhesion member. The device further includes a protection member formed on the terminal region to cover at least a portion of the terminal region included in the plasma display panel but and a peripheral region of the terminal region.

### CROSS-REFERENCE TO RELATED APPLICATIONS

This application claims the benefit of Korean Patent Application No. 10-2005-0005376, filed on Jan. 20, 2005, in the Korean Intellectual Property Office, the disclosure of which is incorporated herein in its entirety by reference.

### BACKGROUND OF THE INVENTION

1. Field of the Invention

The present invention relates to a plasma display apparatus, and more particularly, to a plasma display apparatus having an improved structure that can protect connecting portions between terminal units of electrodes and connection members included in a plasma display panel.

2. Description of the Related Technology

A plasma display panel (PDP) is a flat panel display device that displays images using a discharge effect. Due to its high performance characteristics, including a high display capacity, high brightness, high contrast, clear latent image, and large viewing angle, thinness and a large screen size, the PDP is considered to be one of the next generation display devices that will replace the cathode ray tube (CRT).

A plasma display apparatus generally includes a plasma display panel, a chassis base located on the rear of the plasma display panel, circuit substrates mounted on the rear of the chassis base to drive the plasma display panel, and a case that accommodates the plasma display panel, the chassis base, and the circuit substrates.

The plasma display panel displays an image when a fluorescent layer formed in a predetermined pattern is excited by ultraviolet radiation. The ultraviolet radiation is generated during a glow discharge that occurs by applying a predetermined voltages to electrodes formed in a sealed space in which a discharge gas is filled.

The electrodes installed in the plasma display panel respectively include a terminal unit for applying a voltage to the electrodes. The terminal units are extended to be located at least on an edge of the plasma display panel, and the extended terminal units are connected, via a connection portion, to connection members, such as a flexible printed cable (FPC), which are connected to the circuit substrates. A part of the connection portion between the connection members and the terminal units is exposed to the outside. Through the exposed connection portion, moisture penetrates into the connection portion and causes an ion migration phenomenon, which may cause an electrical short. Accordingly, to prevent the penetration of moisture into the connection portion, an outer surface of the connection portion between the connection members and the terminal units is covered with silicon. However, the silicon covers only a fraction of the connection portion. Therefore, there still is a problem of moisture penetrating through the uncovered portion of the connection portion.

### SUMMARY OF CERTAIN INVENTIVE ASPECTS

An embodiment provides a plasma display apparatus that can prevent the penetration of moisture or impurities into terminal units through a connection portion by using a protection member covering outer sides of the connection portion between the terminal units of electrodes and conductive wires of a connection member.

Another embodiment provides a plasma display apparatus including a plasma display panel including a front panel, a rear panel, and a terminal region formed at least on an edge between the front panel and the rear panel to locate terminal units of electrodes that are to be exposed. The embodiment further includes a chassis base located on the rear of the plasma display panel, and at least one circuit substrate located on the rear of the chassis base to drive the plasma display panel, The embodiment further includes a plurality of connection members, each end of which is located on the plasma display panel and other end of which is located on the circuit substrate, and each connection member comprising a wire unit having conductive wires which correspond to the terminal units and are respectively connected to terminal units using an adhesion member; and a protection member formed on the terminal region to cover at least a portion of the terminal region included in the plasma display panel and a peripheral region of the terminal region.

Accordingly, the penetration of moisture or impurities into the connection portion between the terminal units and the conductive wires may be prevented, and as a result, the ion migration at the connection portion between the terminal units and the conductive wires may not occur, thereby preventing short circuits.

In another embodiment, the terminal region may be formed at least on a side of the rear panel extended further than the front panel, and the terminal units of the electrodes on the rear panel may be located on the terminal region. The protection member may be formed on outer sides of the wire unit located on the terminal region and on a front surface of the front panel adjacent to the terminal region.

In another embodiment, the terminal region may be formed on the front panel extended to at least a side further than the rear panel, and the terminal units of electrodes comprised in the front panel may be located in the terminal region. The protection member may be formed on outer sides of the wire unit located on the terminal region and on a rear surface of the rear panel adjacent to the terminal region.

### BRIEF DESCRIPTION OF THE DRAWINGS

The above and other features and advantages of the present invention will become more apparent by describing in detail exemplary embodiments thereof with reference to the attached drawings in which:

FIG. 1 is an exploded perspective view of an embodiment of a plasma display apparatus;

FIG. 2 is a partial perspective view of an example of a plasma display panel of FIG. 1;

FIG. 3 is an exploded perspective view showing the connection of connection members to terminal units included in the electrodes of FIG. 1;

FIG. 4 is a cross-sectional view of the connection members before connecting them to the terminal units of FIG. 3; and

FIG. 5 is a cross-sectional view of an example configuration of a protection member after the terminal units and the connection members of FIG. 4 are connected.

### DETAILED DESCRIPTION OF CERTAIN INVENTIVE EMBODIMENTS

The present invention will now be described more fully with reference to the accompanying drawings in which exemplary embodiments of the invention are shown.

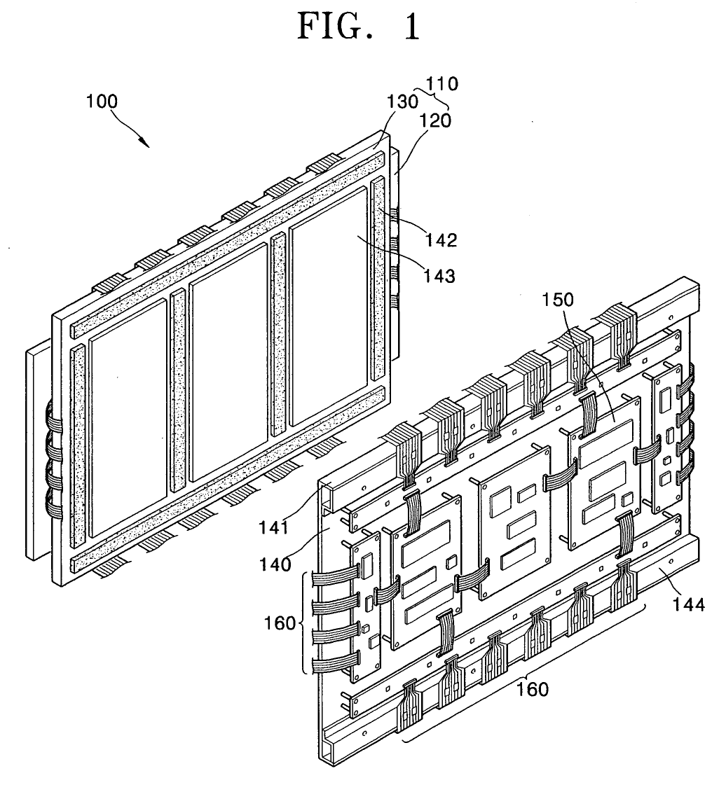

FIG. 1 is an exploded perspective view of an embodiment of a plasma display apparatus. Referring to FIG. 1, a plasma display apparatus 100 includes a plasma display panel 110 capable of displaying an image.

A chassis base 140 is located on the rear of the plasma display panel 110. The chassis base 140 may be formed of a material such as aluminum. The chassis base 140 is located parallel to the plasma display panel 110 to support the plasma display panel 110 and to dissipate heat transferred from the plasma display panel 110 to the outside. The chassis base 140 may include a lip 141 bent backward on an edge of the chassis base 140 to prevent the chassis base 140 from bending or distorting. Also, reinforcing members 144 may be installed on the rear of the chassis base 140. The reinforcing members 144 may be formed of a metal and coupled to the rear surface of the chassis base 140 to prevent the chassis base 140 from bending or distorting. Also, the reinforcing members 144 contribute to the total heat dissipation area, thereby increasing the heat dissipation efficiency.

The chassis base 140 is coupled to the plasma display panel 110 using an adhesive member 142 such as a double-sided tape. A heat dissipation member 143 is interposed between the chassis base 140 and the plasma display panel 110 to dissipate heat generated from the plasma display panel 110 to the environment.

Circuit substrates 150 for driving the plasma display panel 110 may be mounted on the rear of the chassis base 140. In order to drive the plasma display panel 110, the circuit substrates 150 include various electronic parts. The circuit substrates 150 are accommodated in a case (not shown) together with the plasma display panel 110 and the chassis base 140. The circuit substrates 150 are electrically connected to the plasma display panel 110 via a connection member 160 to transmit signals to the plasma display panel 110. The connection member 160 may be a FPC or a tape carrier package (TCP), which is an FPC that includes at least an electronic device.

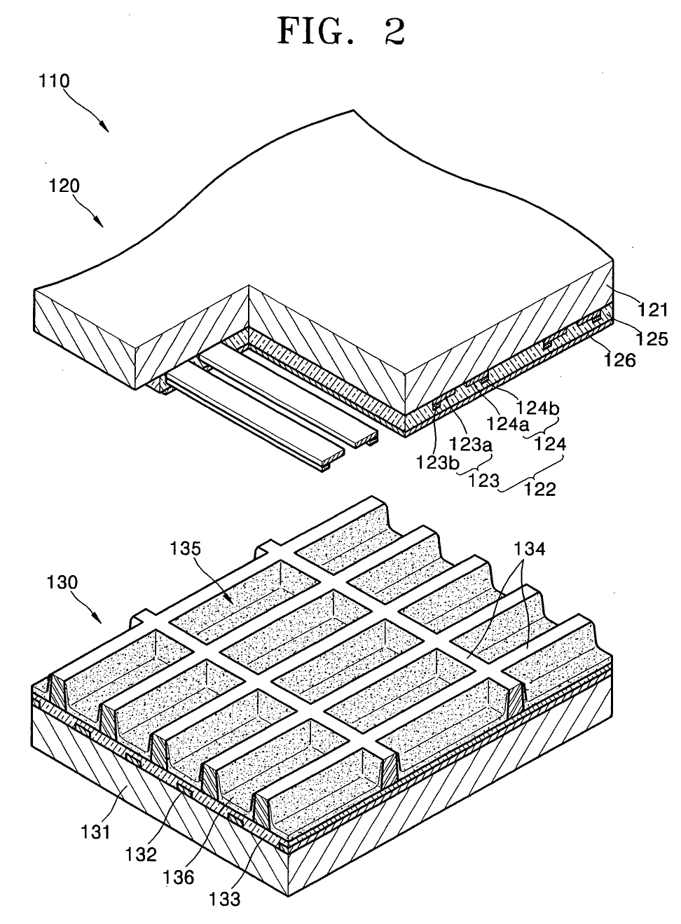

In the embodiment shown in FIG. 1, the connection members 160 located on left and right hand sides of the chassis base 140 and connected to the circuit substrates 150 are FPCs, and the connection members 160 located on upper and lower parts of the chassis base 140 and connected to the circuit substrates 150 are TCPs. The TCPs are separated from each other, and an end portion of each of the TCPs is connected to address electrodes 132 (see FIG. 2). The address electrodes 132 have an address function and are located in the plasma display panel 110 on edges of the upper part and lower part of the chassis base 140. Another end portion of each of the TCPs is connected to driving units (not shown) that drive the address electrodes 132 of the circuit substrates 150.

The plasma display panel 110 that is electrically connected to the circuit substrates 150 via the connection members 160 can be one of the various types of plasma display panels. As an example embodiment, the plasma display panel 110 may be an alternating voltage type plasma display panel having a surface discharge type three-electrode structure as depicted in FIG. 2. The plasma display panel 110 includes a front panel 120 and a rear panel 130 which is coupled to and faces the front panel 120.

The front panel 120 includes a front substrate 121 located in front of the front panel 120, sustain electrode pairs 122 located on the rear surface of the front substrate 121 and composed of an X electrode 123 and a Y electrode 124, a front dielectric layer 125 covering the sustain electrode pairs 122, and a protection film 126 formed on the rear surface of the front dielectric layer 125. The X electrode 123 and the Y electrode 124 are separated by a discharge gap and respectively function as a common electrode and a scanning electrode. The X electrode 123 includes an X transparent electrode 123a and an X bus electrode 123b formed to connect to the X transparent electrode 123a. Also, the Y electrode 124 includes a Y transparent electrode 124a and a Y bus electrode 124b formed to connect to the Y transparent electrode 124a.

The rear panel 130, which is coupled to the front panel 120, includes a rear substrate 131 located on the rear of the rear panel 130, and a plurality of address electrodes 132 which are formed on the front surface of the rear substrate 131 and extending in a direction crossing the sustain electrode pairs 122. The rear panel 130 also includes a rear dielectric layer 133 covering the address electrodes 132, a plurality of matrix shaped barrier ribs 134 formed on the front surface of the rear dielectric layer 133 to define a plurality of discharge cells 135, and a phosphor layer 136 located in each of the discharge cells 135. The discharge cells 135 respectively correspond to regions where the sustain electrode pairs 122 cross the address electrodes 132. A discharge gas is contained in the discharge cells 135.

An end portion of each of the X electrodes 123 and the Y electrodes 124 included in the plasma display panel 110 is extended into a terminal region on at least one edge portion (or shelf) of the front substrate 121 (e.g., a terminal region shelf of the front substrate 121 extending beyond the side of the rear substrate 131). An end portion of each of the address electrodes 132 is extended to form a terminal region on at least one edge portion (or shelf) of the rear substrate 131 (e.g., a terminal region shelf of the rear substrate 131 extending beyond the side of the front substrate 121). The end portion of each of the electrodes 123, 124, and 132 is extended into the terminal region, which is located on edges of the front substrate 121 and the rear substrate 131, to form a terminal unit. The terminal units are connected to the circuit substrates 150 via the connection members 160 to apply a voltage to each of the electrodes 123, 124, and 132 by the circuit substrates 150.

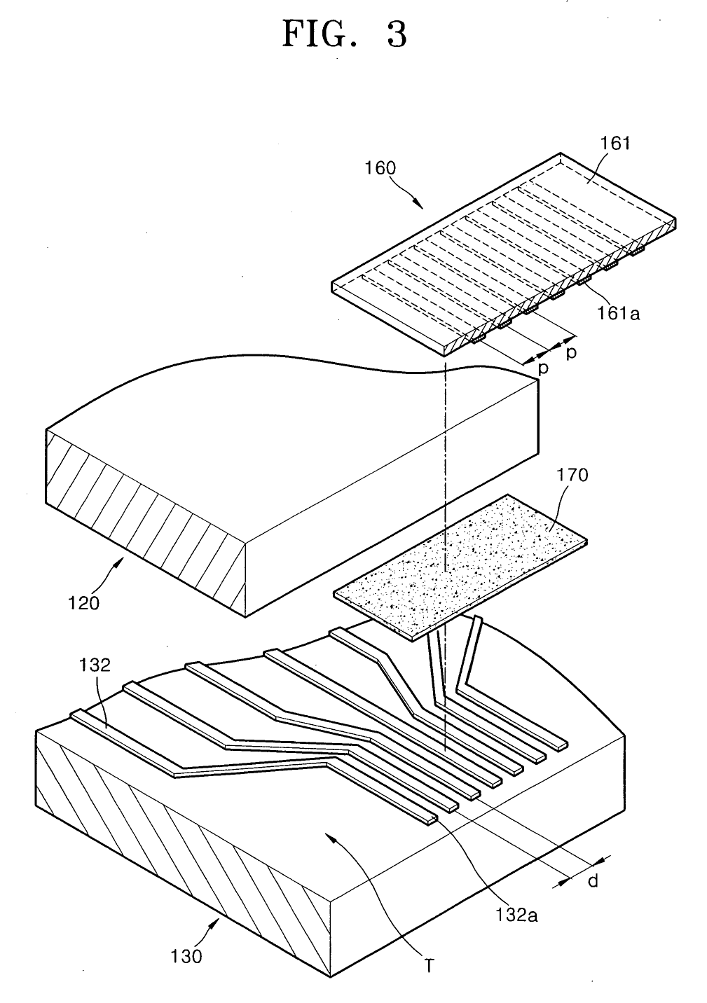

An embodiment of the connection of the terminal units and the connection members 160 will now be described in detail with reference to FIG. 3.

FIG. 3 is an exploded perspective view showing terminal units extended to an edge of a substrate before being connected to connection members. The substrate may be part of the front panel 120 or the rear panel 130, and the terminal units may be terminals including the X electrodes 123, the Y electrodes 124, or the address electrodes 132. As an example, the terminal units of the address electrodes 132 extended to a terminal region located on an edge of the rear substrate 131 will now be described.

Referring to FIG. 3, each end portion of the address electrodes 132 includes terminal units 132a. The terminal units 132a are extended to a terminal region T located on an edge of the rear panel 130 and arranged in a row with a space between any adjacent units 132a. A connection member 160 is located in a position corresponding to the terminal units 132a. The connection member 160 includes a wire unit 161 having a plurality of conductive wires 161a. Each of the conductive wires 161a of the wire unit 161 corresponds to one of the terminal units 132a, and, in the embodiment shown, has a pitch “p” substantially equal to the distance “d” between the terminal units 132a so that each of the conductive wires 161a can overlay, at least partially, with one of the terminal units 132a.

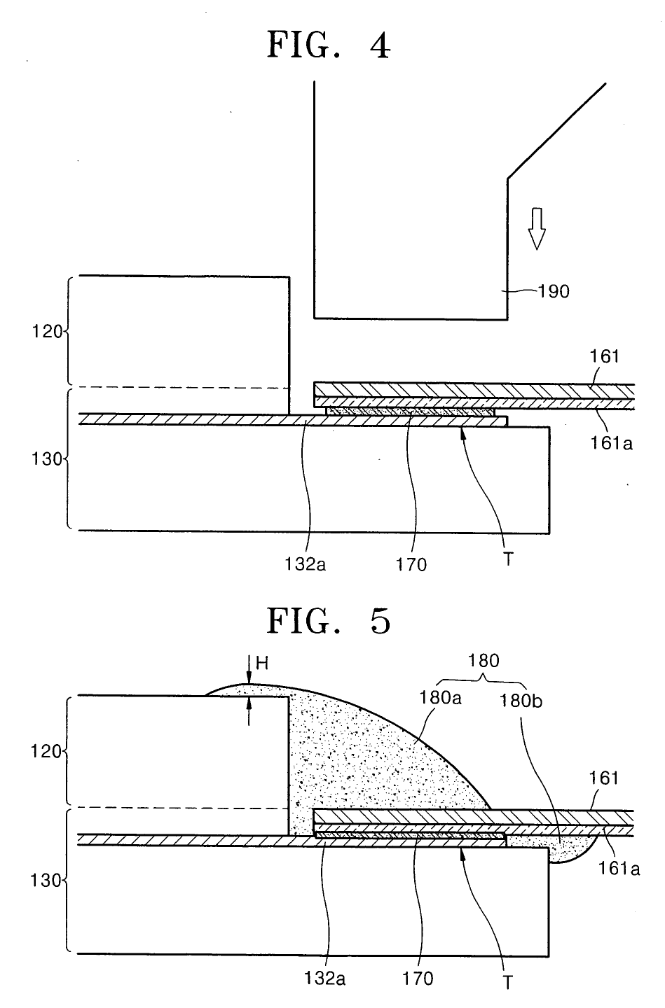

An adhesive member, for example, an anisotropic conductive film 170, is interposed between the overlaid conductive wires 161a and the terminal units 132a, and is compressed to connect the conductive wires 161a to the terminal units 132a. In one embodiment, the anisotropic conductive film 170 includes uniformly distributed conductive balls, comprised of nickel particles plated with gold. In other embodiments, other materials and configurations may be used. When the anisotropic conductive film 170 is heated and compressed between the conductive wires 161a and the terminal units 132a using a thermal compression apparatus 190 as depicted in FIG. 4, the conductive balls (the conductive balls contained in the anisotropic conductive film 170) located in the overlapped portions between the conductive wires 161a and the terminal units 132a, penetrate into both the conductive wires 161a and the terminal units 132a (as depicted in FIG. 5). Therefore, the terminal units 132a are connected to the conductive wires 161a.

In the embodiment depicted in FIG. 5, after the terminal units 132a are connected to the conductive wires 161a by the anisotropic conductive film 170, portions of the terminal region T, where the wire unit 161 of the connection member 160 is not located, are exposed to the environment. Through the exposed portions of the terminal units 132a on the terminal region T, moisture or impurities may penetrate into the terminal units 132a and may cause ion migration resulting in a short circuit. Therefore, as depicted in FIG. 5, to prevent the penetration of moisture or impurities, the exposed portions of the terminal units 132a are covered by a protection member 180 that includes a first protection member 180a and a second protection member 180b.

In the embodiment depicted in FIG. 5, the protection member 180a covers the exposed portions of the terminal units 132a in the terminal region T, and also is extended to cover a peripheral region of the terminal region T. That is, as depicted in FIG. 5, the protection member 180a is formed on a portion of an outer surface of the wire unit 161 located on the terminal region T, that is, a portion of an outer surface opposite to the portion connected to the terminal units 132a. The protection member 180a is also formed on a portion of the front surface of the front panel 120 adjacent to the terminal region T to cover the exposed portions of the terminal units 132a in the terminal region T and the peripheral region thereof.

In the present embodiment, the terminal units 132a included in the address electrodes 132 are described as an example. In the case of terminal units including the X electrodes 123 and the Y electrodes 124, the protection member 180a is formed on a portion of an outer surface of the wire unit located on the terminal region T, a portion of an outer surface opposite to the portion connected to the terminal units and on the entire rear surface of the rear panel 130 adjacent to the terminal region to cover the terminal region T and the peripheral region thereof.

The protection member 180a can be formed by coating an ultraviolet (UV) curable resin such as a silicon resin or an epoxy resin on the above described regions and hardening the coated resin. The protection member 180a may be designed to have a maximum height H (as shown in FIG. 5) protruding from the front surface of the front panel 120 in a range of about 0.3 to about 2 μm. When the maximum height H of the protection member 180a is lower than about 0.3 μm, the penetration of moisture or impurities may not be sufficiently prevented. On the contrary, when the maximum height H is higher than about 2 μm, the hardening of the resin may require a long time. Although it is not depicted, the protection members 180 may include a third protection member configured to cover portions of the wire unit 161 located on the terminal region T. The portions of the wire unit 161 include periphery regions of the wire unit 161 in a direction parallel to the direction of the conductive wires 161a and regions of the rear panel 130 adjacent to the periphery regions of the wire unit 161.

Since the protection member 180a is extended to cover not only the terminal region T but also the peripheral regions of the terminal region T, the exposed terminal units 132a and the connected portions between the terminal units 132a and the conductive wires 161a are completely covered. Therefore, the penetration of moisture through the connected portions between the terminal units 132a and the conductive wires 161a may be minimized.

In addition to the exposed portions of the terminal units 132a discussed above, end portions of the terminal units 132a overlapped with the conductive wires 161a are also exposed to the environment, as shown in FIG. 5. To prevent the penetration of moisture or impurities through the exposed end portions of the terminal units 132a, a protection member 180b that can cover peripheral regions of the terminal units 132a may also be formed. For this purpose, as depicted in FIG. 5, the protection member 180b is formed on the outer portions of the plasma display panel 110, that is, the outer portions of the rear panel 130 and the wire unit 161 adjacent to the rear panel 130 to cover end portions of the terminal units 132a and portions of the conductive wires 161a.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display apparatus comprising:
a plasma display panel comprising a front panel, a rear panel, and a terminal region formed at least on an edge between the front panel and the rear panel to locate terminal units of electrodes that are extended so as to be exposed;
a chassis base located on the rear of the plasma display panel;
at least one circuit substrate located on the chassis base, the circuit substrate being configured to drive the plasma display panel;
a plurality of connection members, each comprising a first end located on the plasma display panel and a second end located on the circuit substrate, and each connection member further comprising a wire unit having conductive wires which correspond to the terminal units and are connected to the terminal units using an adhesion member; and
a protection member covering at least a portion of the terminal region in the plasma display panel and a peripheral region of the terminal region.

2. The plasma display apparatus of claim 1, wherein the terminal region is formed at least on a side of the rear panel which extends outwardly from an edge of the front panel, and the terminal units of the electrodes are located on the terminal region.

3. The plasma display apparatus of claim 2, wherein the protection member is formed on outer portions of the wire unit located on the terminal region and on a front surface of the front panel adjacent to the terminal region.

4. The plasma display apparatus of claim 3, wherein a maximum height that the protection member protrudes from a front surface of the front panel is in a range of about 0.3 μm to about 2 μm.

5. The plasma display apparatus of claim 3, wherein the protection member is further formed on outer portions of the rear panel and on outer portions of the wire unit, the protection member being configured to cover peripheral regions adjacent to edges of the terminal units.

6. The plasma display apparatus of claim 1, wherein the terminal region is formed at least on a side of the front panel which extends outwardly from an edge of the rear panel, and the terminal units of electrodes are located on the terminal region.

7. The plasma display apparatus of claim 6, wherein the protection member is formed on outer portions of the wire unit located on the terminal region and on a rear surface of the rear panel adjacent to the terminal region.

8. The plasma display apparatus of claim 7, wherein a maximum height that the protection member protrudes from a rear surface of the rear panel is in a range of about 0.3 μm to about 2 μm.

9. The plasma display apparatus of claim 7, wherein the protection member is further formed on outer portions of the front panel and outer portions of the wire unit, the protection member being configured to cover peripheral regions adjacent to edges of the terminal units.

10. The plasma display apparatus of claim 1, wherein the protection member is formed of a material comprising at least one of a silicon resin and an ultraviolet hardening resin.

11. A plasma display panel device, comprising:
a connector;
an electrode;
an adhesive member disposed between at least a portion of the connector and the electrode; and
sealant covering at least a portion of the connector and the electrode.
